(19) United States
(12) Patent Application Publication
(10) Pub. No.: US 2006/0237119 A1
(43) Pub. Date: Oct. 26, 2006

(54) Paper based product and method of making same

(76) Inventor: Shirley C. Rosel, Las Pinas City (PH)

Correspondence Address: DUANE MORRIS LLP, 1667 K. STREET, N.W., SUITE 700, WASHINGTON, DC, 20006-1608, US

(21) Appl. No.: 11/429,977

(22) Filed: May 9, 2006

(30) Foreign Application Priority Data
Dec. 1, 1999 (PH) 1-1999-03008

(51) Int. Cl. B32B 37/00; H01F 41/12; B29C 63/10; B32B 27/10; B32B 38/04; B29C 70/34

(52) U.S. Cl. 156/185; 156/187; 156/191; 156/264; 428/34.2

(57) ABSTRACT

Method for making rolled paper material comprising the steps of dividing a sheet of paper into portions, rolling each portion of paper about a piece of broomstick, removing the piece of broomstick from the rolled portion, and gluing the rolled portion to preventing it from unrolling. Once such material is manufactured, other paper based product may be constructed.

### BACKGROUND OF THE INVENTION

1. Field of the Invention

The present invention relates to methods of making paper based products. More particularly, the present invention relates rolled paper products and methods of making the same.

2. Description of the Related Art

Ornamental, as well as functional products made from paper materials are well known and widely used. Such paper products are made from various kinds of paper based materials, such as paper mache', paper pulp, chipboards and the like. Paper products of late come in many different forms, sizes, and shapes and perform numerous functions. For example, paper based materials and manufacturing techniques have been used to make elaborate and decorative paper mache' picture frames and the like. Unfortunately, manufacturing such paper products often can be very difficult as well as expensive to produce due to the use of costly machines and the like.

Thus, there is a need for new and improved methods for making paper products. Such new and improved methods must allow manufacturers to produce paper based products more efficiently and cost effectively.

### SUMMARY OF THE INVENTION

In view of the aforementioned cost problems, it is therefore a primary object of the present invention to provide methods for making decorative and functional paper based products that are less costly.

It is another object to the present invention to provide methods of making decorative and functional paper products from raw materials that include, but are not limited to, materials similar or like telephone books and the paper they contain.

It is another object to the present invention to provide a method of making decorative and functional paper products that does not require the use of costly machines, paper molds, etc.

In achieving its stated objects, the present invention permits the manufacture of new paper based products such as new and improved paper based trays, planters, picture frames, decorative boxes, baskets, room dividers, bags, lampshades, jars, vases, placemats, etc.

Other objects and advantages of the invention will be apparent upon reading the following description taken in conjunction with the accompanying drawing figures, which are described below.

The present invention achieves its stated objects by providing a method for making rolled paper material comprising the steps of dividing a sheet of paper into portions, rolling each portion of paper about a piece of broomstick, removing the piece of broomstick from the rolled portion and gluing the rolled portion to prevent it from unrolling. Once such material is manufactured, other paper based structures may be constructed.

### BRIEF DESCRIPTION OF THE DRAWING FIGURES

The present invention is described in detail below with reference to the attached drawing figures, of which:

FIG. 1 shows a typical sheet of paper (e.g., telephone book paper, etc.) that may be used to facilitate a method of making paper based products in accordance with a preferred embodied of the present invention;

FIG. 2 is a depiction of a strip of paper being wrapped around a piece of broomstick or other similar cylindrical type object (or other similarly shaped object) in accordance with a preferred embodiment of the present invention;

FIG. 3 is a depiction of the method steps involved in removing the piece of broomstick shown in FIG. 2 from the rolled paper and applying glue thereto, in accordance with a preferred embodiment of the present invention;

FIG. 4 is a depiction of rolled paper strips being glued together to form a board like structure that may be used to manufacture a paper based product in accordance with a preferred embodiment of the present invention; and

FIG. 5 is a depiction of a paper based product in the form of a tissue box which as been constructed in accordance with a preferred embodiment of the present invention.

### DETAILED DESCRIPTION OF THE PREFERRED EMBODIMENTS

The present invention is now discussed in detail with regard to the attached drawing figures which were briefly described above. Unless otherwise indicated, like parts and processes are referred to with like reference numerals.

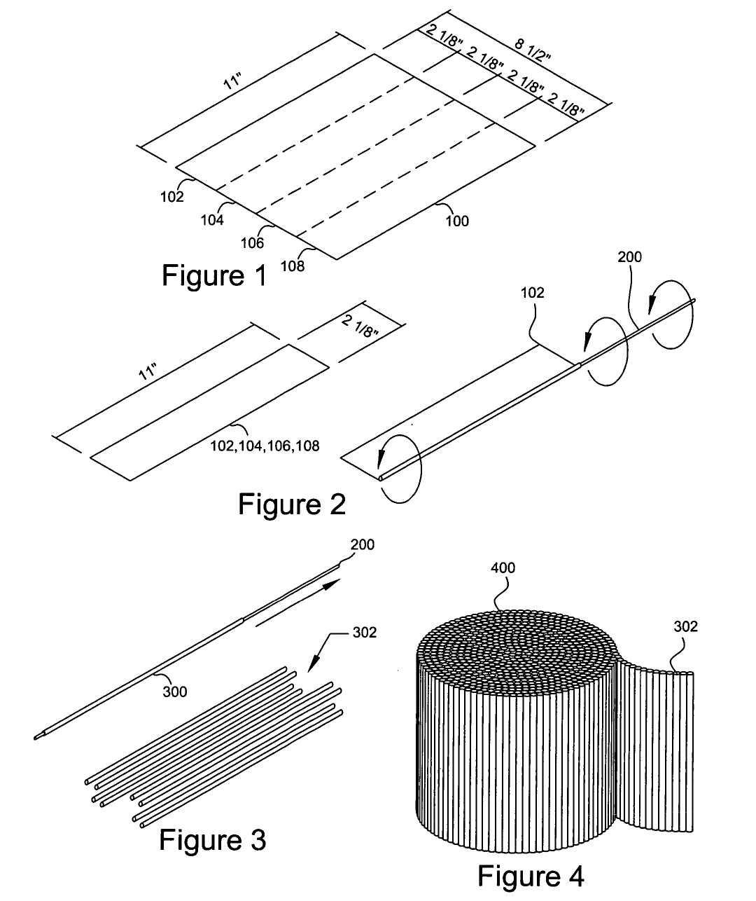

Referring now to FIG. 1, depicted therein is a sheet of paper such as telephone directory or book type paper, etc. (e.g., newsprint, etc.) which as been selected as the raw material to be used for making a paper based product in accordance with a preferred embodiment of the present invention. In particular, paper 100 is divided into 4 strips or portions 102-108. In a typical embodiment, the pages from telephone directories or books are used to provide the materials necessary to facilitate the method described herein. Accordingly, paper 100 is an exemplary 8½× 11″ sheet of paper. Each strip 102-108 is shown to be one quarter of the width of sheet 100, or 2⅛ wide each and 11″ long.

Referring now to FIG. 2, depicted therein are the method steps of wrapping a strip or portion of paper 102 around a piece of broomstick 200 (e.g., straw, wood, etc.). In particular, a strip of paper 102 is tightly rolled lengthwise around a thin piece of broomstick 200. The diameter of the piece of broomstick 200 may vary based on thickness of the rolled paper desired. It is shown here that the piece of broomstick may be extremely narrow in comparison to the width of the paper, however the invention is not so limited. The strip of paper 102 may be wrapped and rolled about the piece of broomstick 200 by hand (manually), for example, by rotating the stick while keeping the paper taught. In the context of the present invention, the term “broomstick” is intended to mean an object about which paper may be rolled. Accordingly, a broomstick may be any object such as a cylindrically shaped object such as a round cylindrically shaped object, a hexagonally cylindrical shaped object, etc.

FIG. 3 illustrates the method steps of removing the broomstick 200 from the wrapped sheet of paper 300 (102). Such operation may be carried out by hand. It will be appreciated that what is produced is a relatively tightly rolled sheet of paper 300. The ends of rolled sheet 300 may be glued with a commercially available glue, such as white glue (e.g., ELMER'S™ white glue). As further shown in FIG. 3, a plurality of rolled and glued sheets 302 may be used as building materials for making a variety of paper based products, such as, trays, planters, balloons, picture frames, decorative boxes, baskets, room dividers, bags, lampshades, jars, vases, placemats, etc.

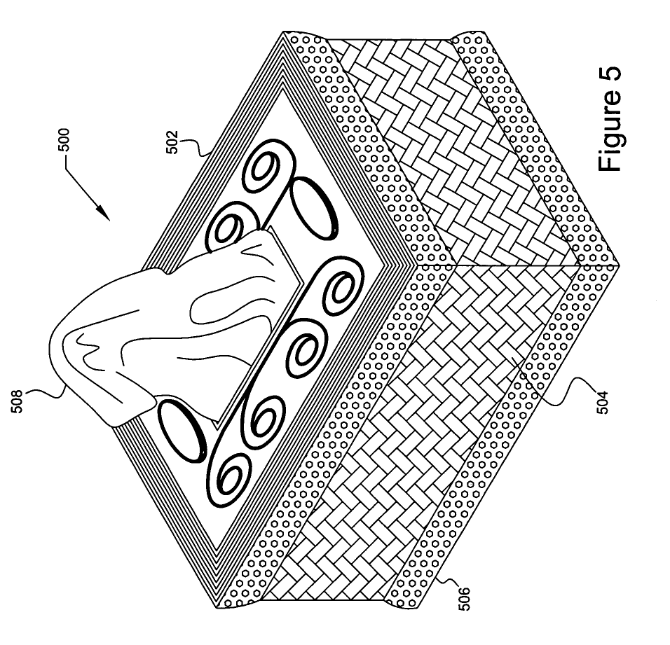

Referring now to FIG. 4, depicted therein are a number of rolled sheets 302 which have been glued together to form a roll 400. Such a roll 400 may be used as a manufactured material to build or otherwise construct various paper based products such as a basket, a tissue box like or similar to the one shown in FIG. 5 (discussed below), etc. Moreover, the resulting material forming cardboard roll 400 may be varnished, stained, painted, etc. to provide water proofing properties, additional strength, decorative properties, etc. Here, the structure created as shown in merely a cardboard roll (i.e., a roll of secured, rolled paper sticks 302), however the invention is not so limited. It will be readily appreciated by one having ordinary skill in the art that a tightly rolled and glued sheet of paper, such as rolled sheets 302, may be used to construct a variety of decorative and functional paper products, such as by gluing or weaving the same. Also, it will be understood that once a product has been constructed from such rolled paper, that the product may be varnished, painted or otherwise finished appropriately.

Referring now to FIG. 5, depicted therein is a paper based product in the form of a decorative tissue box or dispenser which has been constructed from paper based materials in accordance with the methods provided by the present invention. In particular, tissue box 500 is a product made according to the method steps and processes described therein. That is, tissue box 500 includes a body which further includes a top member 502 made from a sheet of rolled sheets of paper such as rolled sheets 302 (FIG. 3), sides 504 of woven paper sheeting material made from rolled sheets of paper constructed in accordance with the present invention, and decorative members 506 which have been constructed, in this example, using individual rolled paper rods like those making up rolled sheets 302. Tissue box 500 may be assembled using glue and varnishes as described herein to achieve desired levels of rigidness, wearability, and water or like fluid repellency or water-proofness. For example, since tissue box 500 may be used in a moist, bathroom environment, a manufacturer is well advised to use a water or like fluid repellent varnish or coating to ensure that underlying paper does not become soaked and damaged. Once constructed, tissue box 500 may be set into operation to be used to dispense tissues 508 in a conventional way.

Thus, having fully described the present invention by way of example with reference to the attached drawing figures, it will be readily appreciated that many changes and modifications may be made to the invention and to any of the exemplary embodiments shown and/or described herein without departing from the spirit or scope of the invention which is defined in the appended claims.

What is claimed is:

1. A method for making rolled paper material comprising the steps of:
dividing a single sheet of paper into a plurality of separated portions of paper;
rolling each said portion of paper of said plurality of separated portions of said sheet of paper about the piece of broomstick; and
gluing said rolled portion to prevent if from unrolling.

2. The method according to claim 1, where said dividing step includes dividing said sheet into four (4) equally sized portions.

3. The method according to claim 1, wherein said rolling step includes rolling said portion lengthwise about said piece of broomstick.

4. The method according to claim 1, wherein said piece of broomstick is a piece of straw.

5. The method according to claim 1, wherein said rolling step is performed manually.

6. The method according to claim 1, wherein said sheet of paper is telephone directory type of paper.

7. The method according to claim 1, wherein sheet of paper is newspaper newsprint paper.

8. The method according to claim 1, wherein said gluing step further comprises varnishing said rolled portion.

9. A method for making rolled paper material comprising the steps of:
cutting pages from a telephone directory;
dividing each said page of said pages into portions;
rolling each said portion of said sheet about a piece of broomstick until it is completely wrapped about said broomstick;
removing said piece of broomstick from each said rolled portion so that a roll is produced;
gluing each said rolled portion to prevent unrolling;
securing a plurality of said rolled portions to one another to form a product of a desired shape and size; and
applying varnish to said product.

10. The method according to claim 9, wherein white glue is used in said gluing step.

11. The method according to claim 9, wherein securing step including weaving said rolled portions to form a basket type product.

12. The method according to claim 9, wherein said securing step includes weaving and gluing said rolled portions to form a basket type product.

13. The method according to claim 9, wherein said securing step includes gluing said rolled portions to form a basket type product.

14. The method according to claim 9, wherein said piece of broomstick is a piece of straw.

15. The method according to claim 9, wherein said cutting, dividing, rolling, gluing, securing, and applying steps are performed manually.

16. The method according to claim 9, wherein said rolling step includes rolling said portion lengthwise about said piece of broomstick.

17. The method according to claim 9, further comprising the step of decoratively painting said product.

18. A paper based product, comprising:
a body constructed out of rolled paper, said rolled paper being manufactured according to the following method:
dividing a plurality of sheets of paper into portions;
rolling each portion of said portions of said plurality of sheets of paper about a piece of broomstick;
removing said piece of broomstick from said rolled portion; and
gluing said rolled portion to prevent it from unrolling.

19. The paper based product according to claim 18, wherein said body is in the shape of a tissue box.

20. The paper based product according to claim 18, wherein said plurality of sheets of paper are pages from a telephone directory.
